(19) United States
(12) Patent Application Publication
(10) Pub. No.: US 2025/0223876 A1
(43) Pub. Date: Jul. 10, 2025

(54) JACK LEG SELECTION MANIFOLD

(71) Applicant: Consolidated Rig Works, L.P., Fort Worth, TX (US)

(72) Inventors: Caleb E.M. Fulks, McKinney, TX (US); Jeremey Lawrence, Fort Worth, TX (US)

(21) Appl. No.: 19/013,694

(22) Filed: Jan. 8, 2025

Related U.S. Application Data
(60) Provisional application No. 63/618,747, filed on Jan. 8, 2024.

(51) Int. Cl. E21B 19/086; B66F 3/46; B66F 7/20

(52) U.S. Cl. CPC E21B 19/086; B66F 3/46; B66F 7/20

(57) ABSTRACT

An apparatus includes a plurality of control valves for controlling operation of a plurality of jack legs within a jack leg mechanism. A central control panel generates a mode control signal. A control mechanism selectively activates and deactivates selected ones of the plurality of control valves responsive to the mode control signal from the central control panel and a position of a travel plate associated with the plurality of jack legs.

### CROSS-REFERENCE TO RELATED APPLICATIONS

This application claims benefit of U.S. Provisional Application No. 63/618,747, filed Jan. 8, 2024, entitled JACK LEG SELECTION MANIFOLD (Atty. Dkt. No. CRWK60-35759), the specifications of which are incorporated by reference herein in their entirety.

### TECHNICAL FIELD

The present invention relates to implementation of jack leg modes within a snubbing unit, and more particularly to a centralized system for controlling jack leg mode selection.

### BACKGROUND

Jack legs comprises components of a snubbing unit that provide for the vertical stroke or movement required to run or retrieve a pipe string. Snubbing jack legs are hydraulically operated and can apply extremely high forces to the drill string within a wellhead to which they are attached. Snubbing units normally include four jack legs that are each connected to one corner of the traveling plate assembly. The four jack legs can operate in a variety of different configurations including four leg mode where in all four jack legs are operating and various two leg modes where only a selected two of the four jack legs are operating. Traditional jack leg systems utilize a series of valves for selecting the jack leg mode of operation. The particular jack leg mode of operation is based upon the operational requirements of the snubbing unit. The valves enabling changing of the jack modes normally comprise six ball valves that are located in various places within the jack leg plumbing system. The jack leg mode changing process is a dangerous and time-consuming operation that requires various of the valves having to be accessed which can be difficult especially during operation of the snubbing unit. Thus, an apparatus for enabling easier changing of jack leg modes of operation would be greatly beneficial.

### SUMMARY

The present invention as disclosed and described herein in one aspect thereof includes an apparatus having a plurality of control valves for controlling operation of a plurality of jack legs within a jack leg mechanism. A central control panel generates a mode control signal. A control mechanism selectively activates and deactivates selected ones of the plurality of control valves responsive to the mode control signal from the central control panel and a position of a travel plate associated with the plurality of jack legs.

### BRIEF DESCRIPTION OF THE DRAWINGS

For a more complete understanding, reference is now made to the following description taken in conjunction with the accompanying Drawings in which:

FIG. 1 illustrates a block diagram of the jack leg selection manifold system;

FIG. 2 illustrates a perspective view of the jack leg manifold and associated plumbing;

FIG. 3 illustrates a perspective view of the jack leg manifold

FIG. 4 illustrates a view of the control panel at the operator station for selecting a particular jack leg mode of operation; and

FIG. 5 illustrates a diagram of the valve states for various modes of operation of the jack leg manifold.

### DETAILED DESCRIPTION

Referring now to the drawings, wherein like reference numbers are used herein to designate like elements throughout, the various views and embodiments of the jack leg mode selection manifold are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

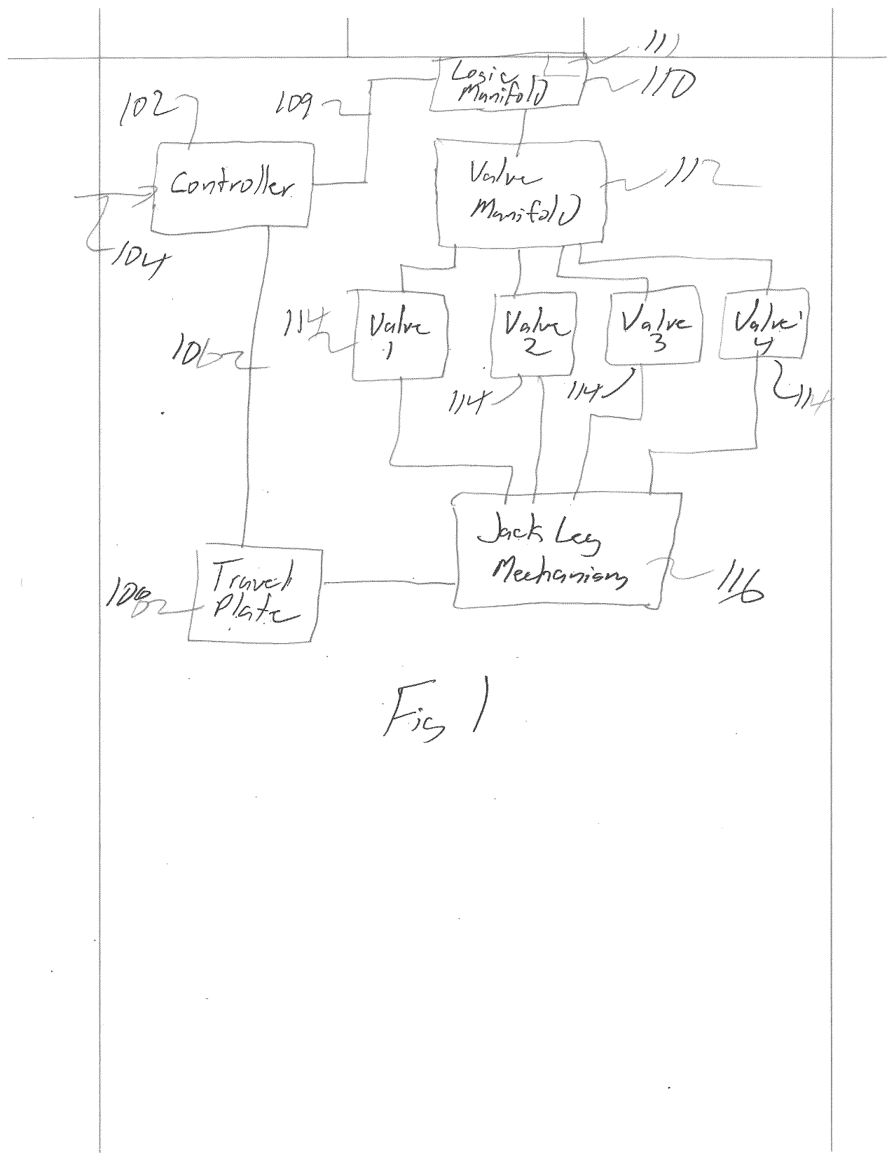

Referring now to the drawings, and more particularly to FIG. 1, there is illustrated a block diagram of the jack leg mode selection manifold system. A controller 102 associated with the rig operator controls enables selection of a particular jack leg mode of operation. The jack leg mode of operation may comprise either a four-leg mode of operation or various two-leg modes of operation based upon the current operating needs of the snubbing system. The controller 102 receives inputs 104 from the drilling rig operators and input 106 from the travel plate 108. The input 106 comprises an indication of a position of the travel plate 108. The jack leg mode of operation is interlocked to the position of the traveling plate 108. For example, in one embodiment, mode selection changes are only implemented when the traveling plate 108 is in the full down position within the snubbing unit.

Responsive to the control inputs 104 from the drilling rig operator and inputs 106 from the travel plate 108, control signals 109 are provided to a logic manifold 110. Logic manifold 110 includes all of the hydraulic circuitry 111 necessary to shift and maintain the selected jack leg mode of operation. The logic manifold 110 utilizes pressure generated by the weight of the traveling plate 108 to operate latching hydraulic circuits 111. The latching circuits 111 maintain position/state with or without a powerpack operating. Logic manifold 110 generates the necessary hydraulic control to the valves 114. The logic manifold 110 contains hydraulic circuitry 111 to shift and maintain the selected jack leg mode by providing hydraulic control signals to the valve manifold. The valve manifold 112 operates of the various valves 114 to control the operation of the jack leg mechanism 116 that places the snubbing unit in the various jack leg modes. While four valves 114 are illustrated with respect to FIG. 1, it will be appreciated that any number of valves may be utilized for operating the jack leg mechanism. The valves 114 can comprise active and inactive poppet valves associated with the valve manifold 112 for placing the system in the selected jack leg mode.

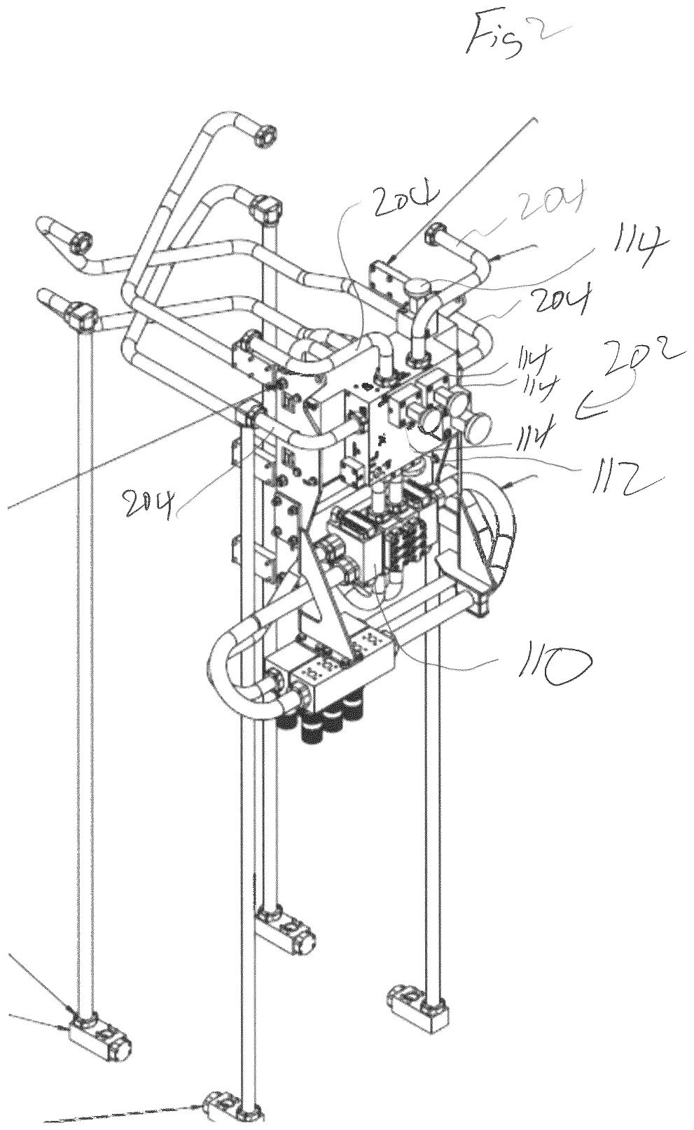

Referring now to FIG. 2, there is illustrated the plumbing associated with the jack leg manifold 202. The valve manifold 112 provides separate outputs 204 to each of the associated jack legs. As discussed previously, the valve manifold 112 controls the operation of various poppet valves 114. The valve manifold 112 receive its control inputs from the logic valve 110. The control inputs to the logic valve 110 from the rig operator and the location of the travel plate 108 are provided.

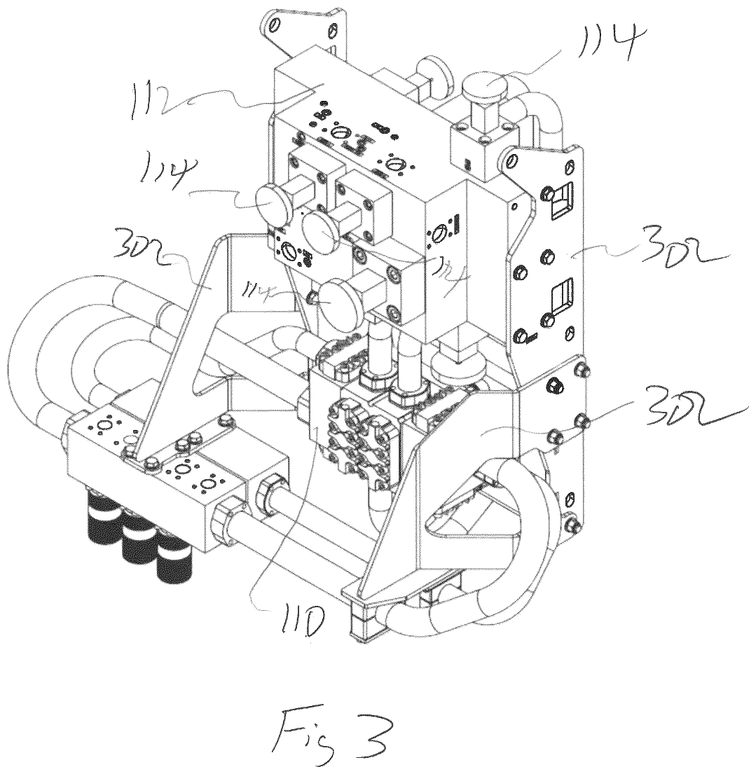

Referring now to FIG. 3, there is more particularly illustrated the valve manifold 112 and associated logic manifold 110. The valve manifold 112 and logic manifold 110 are supported by various support brackets 302 to the jack leg plumbing. The poppet valves 114 are positioned in such a manner to operate the particular jack legs that are to be actuated.

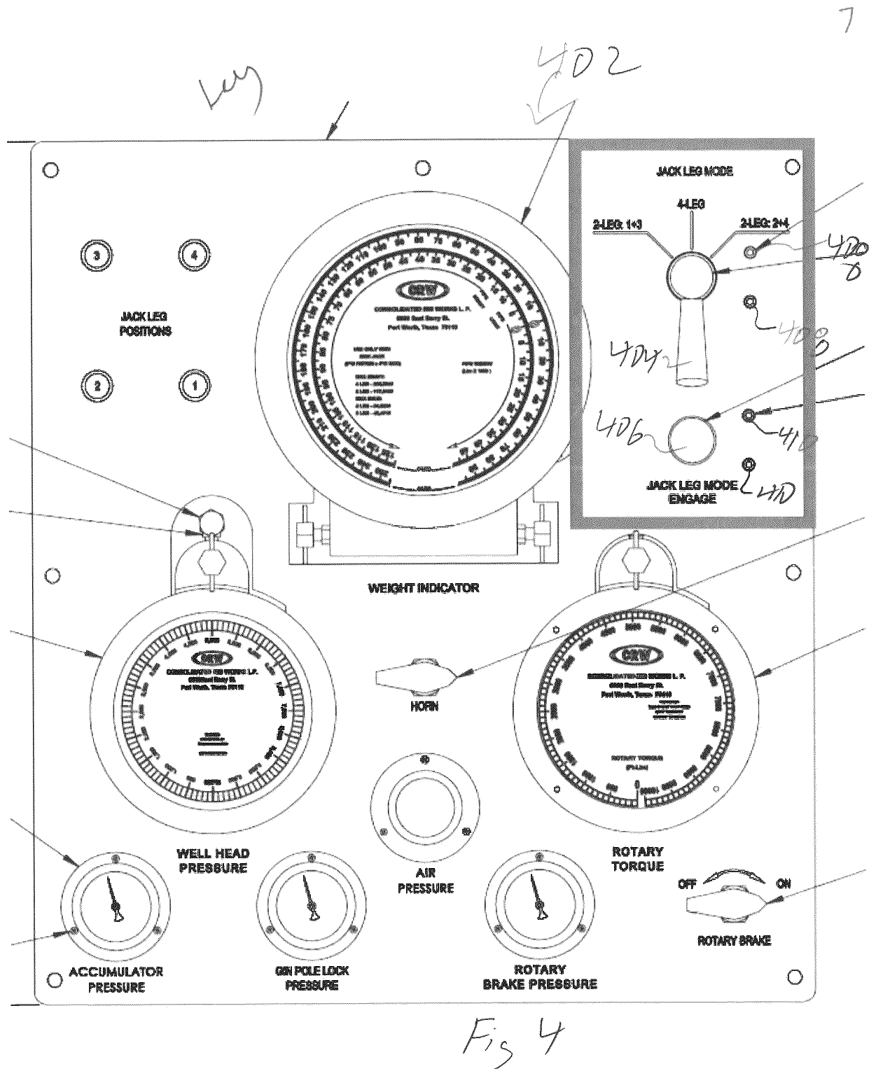

Referring now to FIG. 4, there is illustrated the control panel of the operator that is used for providing the inputs 104 to the logic manifold 110. The control panel 402 includes a jack leg mode switch 404 and a jack leg mode engage button 406. The jack leg switch 404 is used for switching between a four-leg mode of operation, a first two-leg mode of operation involving, e.g., a first pair of jack legs 1 and 3, and a second two-leg mode of operation involving, e.g., a second pair of jack legs 2 and 4. In one embodiment, the first pair of jack legs (e.g., legs 1 and 3) operated (i.e., powered) in the first two-leg mode are connected to the travel plate 108 at a first pair of diametrically opposed portions of the travel plate and the second pair of jack legs (e.g., legs 2 and 4) operated in the second two-leg mode are connected to a second pair of diametrically opposed portions of the travel plate. Indicators 408 are used for indicating the mode of operation selected by the jack leg selection switch 404. Once the desired mode of operation is selected by the jack leg selection switch 404 the jack leg mode is engaged by pressing button actuator 406. The current state of the jack leg mode is indicated using indicator lights 410.

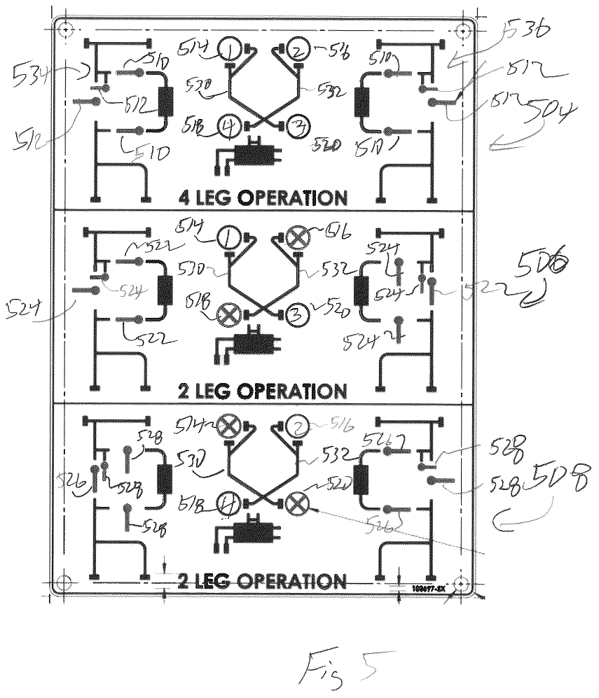

Referring now to FIG. 5, there are illustrated the configurations and positions of the various manifold valves in order to achieve four-leg operation and differing modes of two-leg operation. In FIG. 5, the output to jack leg 1 is denoted 514, the output to jack leg 2 is denoted 516, the output to jack leg 3 is denoted 520 and the output to jack leg 4 is denoted 518. The different valve positions can be selected by the operator, e.g., by using the jack leg mode switch 404 of the control panel 402 shown in FIG. 4. The valve configuration denoted 504 generally illustrates the valve positions selectable for four-leg mode of operation. The valve configuration 506 generally illustrates the valve positions selectable for a first two-leg mode of operation where jack legs 1 and 3 are turned on while the valve configuration 508 generally illustrates the valve positions selectable for a second two-leg mode of operation were jack legs 2 and 4 are turned on. In the four-leg mode of operation illustrated at 504, valves 510 are each in the on position while valves 512 are each turned off. This enables each of the outputs 514-520 to jack legs 1-4 to be operating.

In the first 2-leg mode of operation illustrated at 506, the valves 522 are turned on while the valves 524 are turned off. This causes outputs 514 and 520 to jack legs 1 and 3 to be operational while outputs 516 and 518 to jack legs 2 and 4 are turned off. Finally, in the second 2-leg mode of operation illustrated at 508, the valves 526 are tuned on while the valves 528 are turned off. This leaves outputs 516 and 518 to jack legs 2 and 4 operational while outputs 514 and 520 to jack legs 1 and 3 are turned off.

Referring still to FIG. 5, in one embodiment the jack leg selection apparatus can include a first hydraulic header 530 extending between a first pair of jack leg outputs 514 and 520 and a second hydraulic header 532 extending between a second pair of jack leg outputs 516 and 518. The first hydraulic header 530 can be operatively connected to a first valve bank 534 (e.g., left side of 504) including power connections (e.g., left valves 510) and bypass connections (e.g., left valves 512). The second hydraulic header 532 can be operatively connected to a second valve bank 536 (e.g., right side of 504) including power connections (e.g., right valves 510) and bypass connections (e.g., right valves 512). For each respective valve bank, when the respective power connections (e.g., 510) are in the “on” position and the respective bypass connections (e.g., 512) are in the “off” position, the respective connected hydraulic header will supply hydraulic power to respective the jack leg outputs to operate the respective jack legs. For each respective valve bank, when the respective power connections are in the “off” position and the respective bypass connections are in the “on” position, the respective connected hydraulic header will not supply hydraulic power to the respective jack leg outputs to operate the respective jack legs, however, the respective jack legs will be able to move unpowered.

When jack leg selection apparatus is configured as shown at 504 with both first and second valve banks 534, 536 having their respective power connections 510 “on” and bypass connections 512 “off”, then both first and second hydraulic headers 530 and 532 will be supplied with hydraulic power at outputs 514, 516, 518 and 520 to provide four-leg powered operation of the jack legs. When configured as shown at 506 with first valve bank (left side of 506) having its power connections “on” and its bypass connections “off”, but with second valve bank (right side of 506) having its power connections “off” and its bypass connections “on”, then only the first hydraulic header 530 will be supplied with hydraulic power at outputs 514 and 520 to provide power to the respective connected jack legs 1 and 3, while the second hydraulic header 532 will not be supplied with hydraulic power at outputs 516, 518 but instead will allow unpowered movement of the respective connected jack legs 2 and 4. When configured as shown at 508 with first valve bank (left side of 508) having its power connections “off” and its bypass connections “on”, but with second valve bank (right side of 508) having its power connections “on” and it bypass connections “off”, then only the second hydraulic header 532 will be supplied with hydraulic power at outputs 516 and 518 to power to the respective connected jack legs 2 and 4, while the first hydraulic header 530 will not be supplied with hydraulic power at outputs 514, 520 but instead will allow unpowered movement of the respective connected jack legs 1 and 3.

Another embodiment of the new manifold assembly is illustrated in the following appendix. The manifold was redesigned to use hydraulically actuated ball vales instead of active poppets. A new logic manifold and control scheme were designed for this new approach. A “Pull Boost” feature was also added that allows the system to supply up to 5,000 psi to the jack cylinders while isolating/protecting the husco control valve that is only rated for 3000 psi. Pull Boost allows the operator to utilize a 225 k lbs. rated system at 340 k lbs. for short durations/over pull situations.

It will be appreciated by those skilled in the art having the benefit of this disclosure that this the jack leg selection manifold provides a more centralized manner of controlling the jack leg operation. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An apparatus comprising:
a travel plate;
a jack leg mechanism connected to the travel plate including a plurality of jack legs;
a plurality of control valves for controlling operation of the plurality of jack legs within the jack leg mechanism;
a central control panel for generating a mode control signal; and
a control mechanism for selectively activating and deactivating selected ones of the plurality of control valves responsive to the mode control signal from the central control panel and a position of the travel plate.

2. The apparatus of claim 1, wherein the control mechanism further selectively activates and deactivates the select ones of the plurality of control valves responsive to the mode control signal from the central control panel and the travel plate being located in a lowered position.

3. The apparatus of claim 1, wherein the plurality of control valves comprise poppet valves.

4. The apparatus of claim 1, wherein the central control panel enables a selection of one of a four-leg mode of operation, a first two-leg mode of operation for activating a first pair of the plurality of jack legs and a second two-leg mode of operation for activating a second pair of the plurality of jack legs.

5. The apparatus of claim 1, wherein the control mechanism further comprises:
a logic manifold for receiving the mode control signals and generating hydraulic control signals responsive thereto; and
a valve manifold for generating control signal to the plurality of control valves responsive to the hydraulic control signals.

6. The apparatus of claim 5, wherein the logic manifold further comprises hydraulic circuitry to generate the hydraulic control signals to provide a selected jack leg mode by the jack leg mechanism.

7. The apparatus of claim 5, wherein the logic manifold uses weight generated by a weight of the traveling plate to control the hydraulic circuitry.

8. An apparatus comprising:
a plurality of control valves for controlling operation of a plurality of jack legs within a jack leg mechanism;
a central control panel for generating a mode control signal; and
a control mechanism for selectively activating and deactivating selected ones of the plurality of control valves responsive to the mode control signal from the central control panel and a position of a travel plate associated with the plurality of jack legs.

9. The apparatus of claim 8, wherein the control mechanism further selectively activates and deactivates the select ones of the plurality of control valves responsive to the mode control signal from the central control panel and the travel plate being located in a lowered position.

10. The apparatus of claim 8, wherein the plurality of control valves comprise poppet valves.

11. The apparatus of claim 8, wherein the central control panel enables a selection of one of a 4-leg mode of operation, a first 2-leg mode of operation for activating a first pair of the plurality of jack legs and a second 2-leg mode of operation for activating a second pair of the plurality of jack legs.

12. The apparatus of claim 8, wherein the control mechanism further comprises:
a logic manifold for receiving the mode control signals and generating hydraulic control signals responsive thereto; and
a valve manifold for generating control signal to the plurality of control valves responsive to the hydraulic control signals.

13. The apparatus of claim 12, wherein the logic manifold further comprises hydraulic circuitry to generate the hydraulic control signals to provide a selected jack leg mode by the jack leg mechanism.

14. The apparatus of claim 12, wherein the logic manifold uses weight generated by a weight of the traveling plate to control the hydraulic circuitry.

15. A method for controlling an operation of a jack leg mechanism including a plurality of jack legs comprising:
generating a mode control signal at a central control panel responsive to an operator input;
selectively activating and deactivating selected ones of a plurality of control valves using a control mechanism responsive to the mode control signal from the central control panel and a position of a travel plate associated with the plurality of jack legs; and
controlling operation of a plurality of jack legs within a jack leg mechanism responsive to the selectively activated and deactivated plurality of control valves.

16. The method of claim 15, wherein the step of selectively activating and deactivating further comprises selectively activating and deactivating the select ones of the plurality of control valves using the control mechanism responsive to the mode control signal from the central control panel and the travel plate being located in a lowered position.

17. The method of claim 15, wherein the step of generating a mode control signal further comprises selecting of one of a 4-leg mode of operation, a first 2-leg mode of operation for activating a first pair of the plurality of jack legs and a second 2-leg mode of operation for activating a second pair of the plurality of jack legs through a central control panel.

18. The method of claim 8, wherein the step of selectively activating and deactivating further comprises:
receiving the mode control signals at a logic manifold;
generating hydraulic control signals responsive to the mode control signals at the logic manifold; and
generating control signal to the plurality of control valves responsive to the hydraulic control signals at a valve manifold.

19. The method of claim 18, wherein the step of generating the hydraulic control signals further comprises generating the logic control signals using weight of the traveling plate to control the hydraulic circuitry.
